(19) United States
(12) Patent Application Publication
(10) Pub. No.: US 2006/0181130 A1
(43) Pub. Date: Aug. 17, 2006

(54) System for locking and adjusting the tilt of a vehicle seat and method for assembling said system

(75) Inventors: Ingo Kienke, Wermelskirchen (DE); Hans-Rudi Schulz, Remscheid (DE)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 10/550,119

(22) PCT Filed: Mar. 4, 2004
(86) PCT No.: PCT/EP04/02161

§ 371 Date: Sep. 19, 2005

(30) Foreign Application Priority Data
Mar. 19, 2003 (DE) 103 12 136.6

(51) Int. Cl. B60N 2/02

(52) U.S. Cl. 297/353

(57) ABSTRACT

A recliner mechanism system of locking and adjusting tilt of a vehicle seat includes a fitting having a fastening opening and configured to be provided at a side of the vehicle seat. The system also includes an insert part occupying the fastening opening and configured to receive a transmission rod. An inner periphery of the insert part has a profiled contour for receiving the transmission rod in a form-fitting manner.

### CROSS-REFERENCE TO RELATED PATENT APPLICATIONS

The present Application claims the benefit of priority to the following international Applications: PCT Patent Application No. PCT/EP2004/002161 titled “System for Locking and Adjusting the Tilt of a Vehicle Seat and Method for Assembling Said System” filed on Mar. 4, 2004 which published under PCT Article 21(2) on Sep. 30, 2004 as WO 2004/082981 A1 in the German language and German Patent Application No. 103 12 136.6 filed on Mar. 19, 2003 (which are hereby incorporated herein by reference in their entirety).

### BACKGROUND

The present invention generally relates to a system or recliner mechanism for locking and adjusting the tilt of two parts of a vehicle seat, such as a seat base part and a seat backrest part, with respect to each other, comprising two fittings which can be fitted on each side of the vehicle seat and are connected to each other via a transmission rod.

Fittings or recliner mechanisms for adjusting and locking the tilt of two components of a vehicle seat, such as a seat base part and a backrest part, with respect to each other are known. For example, DE 19845698 A1 discloses a fitting for adjusting the tilt of backrests of motor vehicle seats that has a first articulated part and a second articulated part, one of which is connected fixedly to the seat and the other of which is connected fixedly to the backrest. In this case, the second articulated part is coupled pivotably to the first articulated part and has a latching toothing which can be fixed in different pivoting positions by means of a locking lever formed therewith for engagement purposes. The locking lever has a mating toothing corresponding to the latching toothing of the second articulated part. The two toothings can be blocked in engagement positions by means of a blocking lever. The blocking lever is mounted pivotably on the first articulated part and locking lever and blocking lever have mutually complementary control surfaces. The blocking lever in turn bears an arresting lever, which is mounted pivotably, can be displaced via an adjusting means and has a lug which, in a first pivoting position of the arresting lever and in the case of the blocking position of the blocking lever (i.e., the blocking position of the fitting) bears against a stop surface of the first articulated part. In a second pivoting position, the lug is situated away from the stop surface of the first articulated part and therefore enables blocking lever and locking lever to freely pivot, i.e. to be unlocked.

The device according to U.S. Pat. No. 4,836,608 also has a similar construction to the fittings mentioned. DE 19522854 A1 and DE 19845698 mention and illustrate Bowden cables, and U.S. Pat. No. 4,836,608 mentions and illustrates a handling device formed integrally with the clamping element as adjusting means, for moving a structural element of the fitting, such as a clamping element, which is to be pivoted counter to the force of a spring and is also referred to or could be referred to in the documents mentioned as clamping cam, unit of blocking lever and arresting lever, “operation lever” or clamping eccentric. If fittings of this type, which are usually also called “recliners”, are fitted on each side of a vehicle seat, a synchronization is necessary so that the fittings lock in the same angular position in each case during an adjustment of the tilt. In the case of recliners which are activated via Bowden cables, there is not sufficient excess travel in the system, and so an adjustment is necessary in order to compensate for tolerances. This adjustment is usually undertaken in the mechanism on the Bowden cables.

A system of the type described at the beginning, for which a transmission rod is used as the adjusting means, is described in GB 2059496. The transmission or actuating rod engages at both of its ends in fittings which are fitted on each side of a seat. In this case, in particular, the actuating rod can engage axially in each case in a fastening opening of a structural element which serves, for example, for the clamping and has a profiled inner contour for holding the transmission rod in a form-fitting manner. Due to the permissible tolerances of the various structural elements in the recliner, the profiled inner contour which holds the transmission rod can be at different positions from the left recliner to the right recliner. This leads to distortions and makes a compensation necessary. Furthermore, the transmission rod, when passed directly through the seat, may be situated too close to the sitting region, and so it has to be moved via a mechanism.

Accordingly, it would be desirable to provide an improved a system for locking and adjusting the tilt, of the type described at the beginning, using structurally simple means in such a manner that an optimized synchronization between the two fittings, which can be fitted on each side of the vehicle seat. It would also be desirable to provide an improved method for assembling such a system.

### SUMMARY

An exemplary embodiment of the present invention relates to a fitting or recliner mechanism having a molded part which can be inserted into a fastening opening and can be fastened therein and has a profiled inner contour for holding a transmission rod in the fastening opening of the molded part in a form-fitting manner.

Another exemplary embodiment of the present invention relates to a method wherein in a preassembly step, a molded profile part, which has a profiled inner contour for holding a transmission rod in a fastening opening of the molded profile part in a form-fitting manner, is inserted into a fastening opening of the structural element of the fitting, which is preferably situated in a locking position, and is fastened therein, after which, in a main assembly step, the transmission rod is inserted into the fastening opening of the molded profile part.

By providing the molded part, the two fittings can therefore be synchronized at a very early point, (e.g. at their assembly stage, etc.) and do not have to be coordinated with each other later in a further assembly operation. Different fitting positions in each case of the structural element, which has the fastening opening for the transmission rod, which positions may occur due to the permissible tolerances in the two fittings, can thereby be compensated for in a simple manner, and the transmission rod can be fitted in a manner free from distortion. In this case, the profiled inner contour of the molded profile can be oriented in any desired position in an infinitely variable manner advantageously irrespective of the design of the contour of the fastening opening.

Another exemplary embodiment of the present invention relates to a molded part that can be fastened in a fastening opening of a structural element in a frictional and form-fitting manner, in particular by being pressed in. In this case, in order to increase the form-fitting frictional connection, the fastening opening of the structural element can have a profiled structure on its periphery, in particular a fine toothing arranged on its inner circumference.

Another exemplary embodiment of the present invention relates to a recliner mechanism system for locking and adjusting tilt of a vehicle seat. The system includes a fitting having a fastening opening and configured to be provided at a side of the vehicle seat, and an insert part occupying the fastening opening and configured to receive a transmission rod. An inner periphery of the insert part has a profiled contour for receiving the transmission rod in a form-fitting manner.

Another exemplary embodiment of the present invention relates to a method of assembling a recliner mechanism system for locking and adjusting tilt of a vehicle seat. The system includes a two fittings which are configured to be provided at opposite sides of the vehicle seat and coupled to each other via a transmission rod axially aligned with a fastening opening of each fitting. The method of assembling the system includes the steps of inserting an insert part into the fastening opening of at least one of the fittings, the insert part having a profiled inner contour for supporting the transmission rod in a form-fitting manner, coupling the insert part to the fitting, and inserting the transmission rod into the insert part.

Further advantageous embodiments of the invention are contained in the subclaims and in the special description below.

### BRIEF DESCRIPTION OF THE DRAWINGS

The invention is explained in more detail with reference to an exemplary embodiment which is illustrated in the attached drawings, in which:

FIG. 1 is a perspective view of a system for locking and adjusting the tilt according to one exemplary embodiment; and

FIG. 2 is an enlarged, perspective exploded view showing a structural element of a fitting of the system, a molded profile part which can be inserted into the structural element and a transmission rod.

### DETAILED DESCRIPTION

In the FIGURES, identical parts are provided with the same reference numbers, and they are generally also only described once in each exemplary embodiment.

With reference to the FIGURES, a system is provided for locking and adjusting the tilt of two components of a vehicle seat with respect to each other. The system can be used in particular for adjusting the tilt of a seat part and a backrest part.

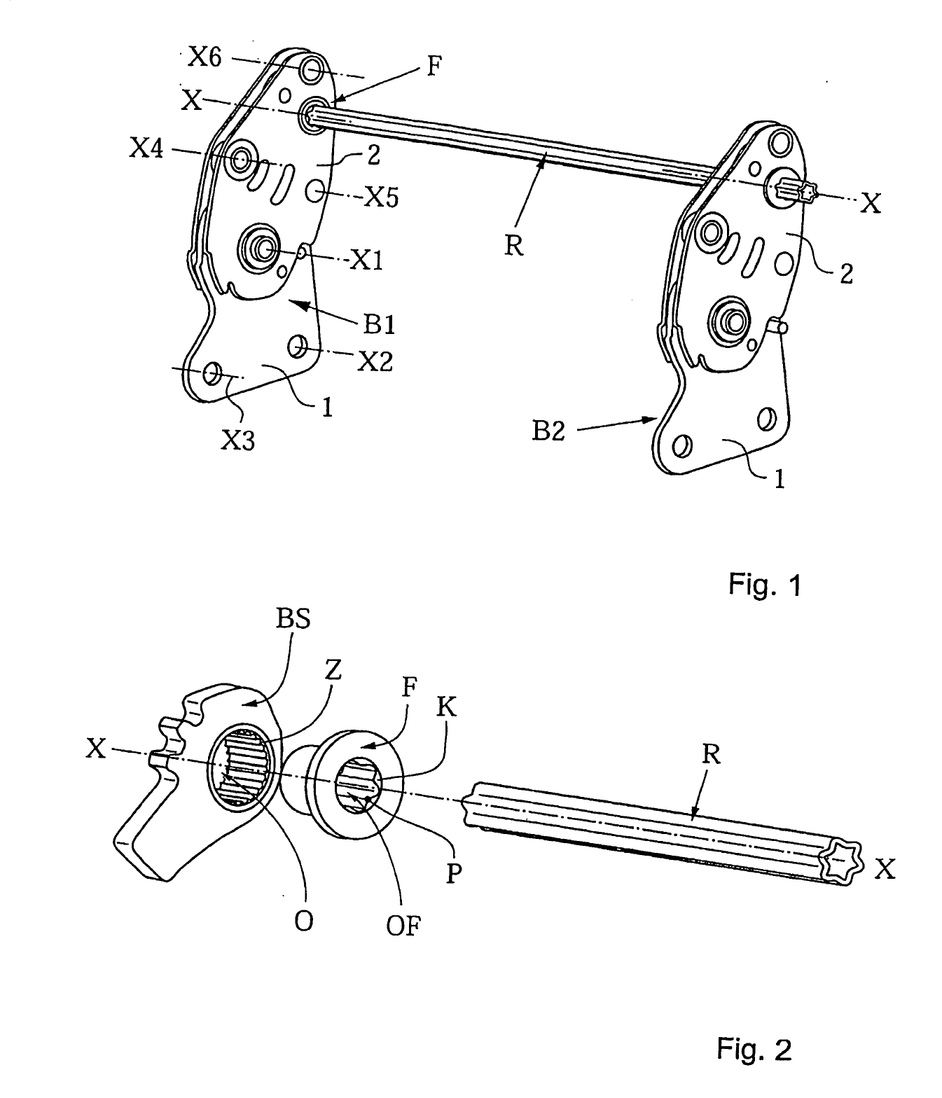

FIG. 1 shows a system of this type comprising two fittings B1, B2 which can be fitted on each side of the vehicle seat and are connected to each other via a transmission rod R acting as an adjusting means.

As FIG. 2 illustrates in detail, the transmission rod R engages axially (axis X-X) a fastening opening O of a structural element BS of a fitting B1, B2. An additional molded profile part F is provided which can be inserted into the fastening opening O of the structural element BS and can be fastened therein and has a fastening opening OF with a profiled inner contour K for holding the transmission rod R in a form-fitting manner.

The structural element BS of the particular fitting B1, B2 in which the transmission rod R can be fastened or is fastened in the installation state may be, for example, a pivotable clamping element of the fitting B1, B2. Each fitting B1, B2 may comprise a first fitting part 1 and a locking element (not illustrated) which can be fixed in certain positions with respect to the first fitting part 1 under the action of a spring and is fastened to a second fitting part 2 which can be fixed in a changeable manner in its tilt in relation to the first fitting part. The clamping element counters the force of the spring as structural element BS serves to cancel the fixing of the locking element on the first fitting part 1.

According to one nonexclusive exemplary embodiment, the fastening opening O of the structural element BS has a profiled structure on its periphery, for example, a fine toothing Z arranged on its inner circumference.

The molded profile part F may be designed, in a favorable manner in terms of production, as a plastic bushing. It may advantageously consist of reinforced plastic, for example a glass fiber reinforced polyamide, such as PA 6.6. GF with 15 percent glass fibers.

The molded profile part F can thereby be fastened in the fastening opening O in a frictional and form-fitting manner (e.g., by being pressed in, etc.) which takes place cold under the formation of chips or is associated with a forming of the outer contour of the molded profile part F after heating, with the result that a secure and rotationally fixed fit in the structural element BS is obtained.

During the fitting in the fastening opening O of the structural element BS, the molded profile part F may be positioned in such a manner that its profiled inner contour K is arranged in a defined position with reference to the fitting B1, B2. With the production of the reference, the fitting B1, B2 should preferably already be in a very substantially assembled and locked state, with the result that the tolerances which are permissible in the unlocking are not effective.

In this case, the defined position may be defined by one or more of a marking point, which is identified by way of example in FIG. 2 by the reference number P, of the profiled inner contour K from one or more reference points of the fitting B1, B2, such as axes of holes present in the fitting. The axes may, on the one hand, be the axes of openings in the first fitting part 1, such as the pivot axis X1 of first fitting part 1 relative to the second fitting part 2 and/or the axes X2, X3 of fastening openings for a component of the seat, such as a seat part, or, on the other hand—as an alternative or in addition—the axes of openings in the second fitting part 2, such as again the pivot axis X1 of first fitting part 1 relative to the second fitting part 2 and/or the axis X4 of a fastening openings of the fixing element and/or the axes X5, X6 of fastening openings for a component of the seat, such as a backrest part. In this case, the reference to the second fitting part 2 may be preferred, since the molded profile part F is fitted in the second fitting part 2 and tolerances which become effective are therefore smaller than with reference to the first fitting part 1, which does not have any direct connection to the molded profile part F. The defined position may be described—as mentioned—by distances, but also by angles being a Cartesian or polar system of coordinates.

The profiled inner contour K of the molded profile part F may be formed—as illustrated—radially symmetrically to its central axis or to the longitudinal axis X-X of the transmission rod R. It is characteristic of rotationally symmetrical figures, such as regular polygons, that they contain as component parts recurring basic figures, such as triangles, which can be brought into overlap by rotation through a certain central angle. This central angle can advantageously be 30°, 60° or 90° in the case of a rotationally symmetrical embodiment of the inner contour K. In the illustration shown, in which the transmission rod R has a hexagonal profile, the central angle is 60°.

As an alternative, the profiled inner contour K of the molded profile part F may also be formed asymmetrically with reference to the longitudinal axis X-X of the transmission rod R. As a result, a coded assembly, i.e. an assembly which can only be carried out in a certain position, of the rod R in the molded profile part F is possible.

According to an exemplary embodiment, the transmission rod R, both in the case of a symmetrical and asymmetrical design of its profile, may have, upon its axial engagement in the profiled inner contour K of the molded profile part, a maximum play of 4°, during a rotational movement about its axis X-X, in particular a play of +/−2°, on each side of the axis X-X. This permissible play facilitates the installation and brings about a further compensation for the tolerance-induced differences in position of the structural element BS in the one fitting B1 and in the other fitting B2, but without the functionality of the system being impaired.

According to an exemplary embodiment of a method of assembling a system for locking and adjusting the tilt of two components of a vehicle seat with respect to each other includes, in a preassembly step, inserting the additional molded profile part F into the fastening opening O of the structural element BS and fastening the molded profile part F therein. This takes place after the fitting B1, B2 as such is already assembled, or is at least partially assembled. The latter means that, in the assembly, individual parts of the fitting B1, B2, such as a wall part or the like, may still be missing. In this case, the operating capability of the fitting B1, B2 is to be produced to the extent such that the locking position can be produced in which the molded profile part F is preferably to be inserted.

According to one exemplary embodiment, in the main assembly, it is possible, to insert the transmission rod R at its ends into the two fittings B1, B2 and then to fit the fittings B1, B2 to the component of the vehicle seat, for example the seat part or backrest part. According to another exemplary embodiment, it is possible for only one fitting B1, B2 to be connected to one end of the transmission rod R in the described manner, and then for both fittings B1, B2—one of which without the molded profile part inserted—to be fastened to the component of the vehicle seat, and only subsequently for the molded profile part F to be inserted into the other fitting B2, B1 in each case and for the other end of the transmission rod R to be inserted into the molded profile part F, with the transmission rod R advantageously serving as an installation aid.

Before the main assembly step is carried out, it is also possible for the fitting B1, B2, without molded profile part F or as a preassembled unit of fitting B1, B2 and molded profile part F, to be subjected to a painting operation, in particular a cathodic dip painting operation, at a temperature of 180° C. to 200° C. The painting is preferably also to be carried out in the locking-position of the fitting B1, B2, so that the bearing surfaces of the corresponding fitting parts, which are in contact in the locking position, are not coated by the paint which would result in the production of further tolerances. In this case the thermal stability of the material of the molded profile part F should preferably exceed the temperatures to be expected during painting. As an alternative, the metallic components may also be painted before the molded profile part F is inserted.

The invention is not restricted to the exemplary embodiments illustrated, but also comprises all of the embodiments acting with the same effect within the context of the invention. Thus, in particular, the shaping of the inner contour K of the profile part F may deviate from the embodiment illustrated. Furthermore, it is also possible for the molded profile part F to be fastened in the fastening opening O of the structural element in a different manner from being pressed in—for example, bonding or injection molding as a type of fastening also appears possible. Injection molding is preferred insofar as the molded profile part F can thereby also be given undercuts which advantageously promote the formation of the form-fitting connection.

Furthermore, those of ordinary skill in the art who review this disclosure will readily appreciate that additional advantageous measures be provided without departing from the framework of the invention. Thus—as likewise illustrated graphically—the transmission rod R can be laid without an additional mechanism in a region which is sufficiently spaced apart from a sitting region—at the front in FIG. 1.

A further advantage, of the system is that unlocking levers which are effective in the fittings B1, B2 can be brought into a standard nominal position, with nominal position being understood to mean a position as has been conceived on the drawing board. For example, this nominal position may be a central position of three possible locking positions with a different tilt of the fitting parts 1, 2 with respect to each other in each case. This advantage may be of importance if the system is used in vehicle seats which are situated in the second or the third row in a motor vehicle, with it also being possible, for example, for three seats arranged next to one another to be provided with the system. The handles used for operating the system can be brought here into the same vertical positions in each case and Bowden cables, which may be provided for the adjustment, of the different systems can be designed with the same, fixedly set length in each case.

With regard to the component BS, it should also be added that this may be a clamping element which is designed in any suitable manner and—as described at the beginning—is referred to as clamping cam, clamping eccentric etc. However, it may also be a component which differs in its design from the known clamping elements.

1-19. (canceled)

20. A recliner mechanism system for locking and adjusting tilt of a vehicle seat, the system comprising:
a fitting having a fastening opening and configured to be provided at a side of the vehicle seat; and
an insert part occupying the fastening opening and configured to receive a transmission rod, wherein an inner periphery of the insert part has a profiled contour for receiving the transmission rod in a form-fitting manner.

21. The system of claim 20, wherein the insert part is press-fit into the fastening opening for coupling the insert part to the fitting in a frictional and form-fitting manner.

22. The system of claim 20, wherein the fastening opening of the fitting has an inner periphery having a profiled contour for receiving the insert part.

23. The system of claim 22, wherein the profiled contour of the fastening opening is an array of fine toothings.

24. The system of claim 20, wherein the insert part is formed of a plastic material.

25. The system of claim 24, wherein the insert part is formed of a glass fiber reinforced polyamide.

26. The system of claim 20, wherein the insert part is inserted into the fastening opening at a predetermined position with reference to the fitting.

27. The system of claim 26, wherein the predetermined position is defined by at least one distance between a reference point on the profiled inner contour of the insert part and a reference point on the fitting.

28. The system of claim 20, wherein the profiled inner contour of the insert part has recurring profiles and is formed radially symmetrical to a longitudinal axis of the transmission rod.

29. The system of claim 28, wherein a central angle, rotation about which the recurring profiles in the profiled inner contour of the insert part can be brought into overlap, is at least one of 30 degrees, 60 degrees, and 90 degrees.

30. The system of claim 20, wherein the profiled inner contour of the insert part is formed asymmetrically with reference to a longitudinal axis of the transmission rod.

31. The system of claim 20, wherein the transmission rod upon axial engagement with the insert part has a maximum play of about 4 degrees during a rotational movement about a longitudinal axis of the transmission rod.

32. The system of claim 20 wherein a pivotable clamping element of the fitting defines the fastening opening occupied by the insert part.

33. A method of assembling a recliner mechanism system for locking and adjusting tilt of a vehicle seat, the system having a two fittings which are configured to be provided at opposite sides of the vehicle seat and coupled to each other via a transmission rod axially aligned with a fastening opening of each fitting, the method comprising:
inserting an insert part into the fastening opening of at least one of the fittings, the insert part having a profiled inner contour for supporting the transmission rod in a form-fitting manner;
coupling the insert part to the fitting; and
inserting the transmission rod into the insert part.

34. The method of claim 33, wherein the step of coupling the insert part to the fitting comprises press-fitting the insert part into the fastening opening to secure the insert part the fitting in a frictional and form-fitting manner.

35. The method of claim 33, wherein the step of inserting the insert part into the fastening opening of the fitting comprises aligning the position of the profiled inner contour of the insert part with reference to the fitting.

36. The method of claim 35, wherein the step of aligning the position of the profiled inner contour of the insert part with reference to the fitting comprises referencing at least one distance between a reference point on the profiled inner contour of the insert part with a reference point on the fitting.

37. The method of claim 33, wherein the transmission rod is inserted into the insert part before the fitting is coupled to a component of the vehicle seat.

38. The method of claim 33, wherein the insert part is inserted into one of the fittings before the fittings are coupled to a component of the vehicle seat and inserted into the other fitting after the fittings are coupled to the component of the vehicle seat.

39. The method of 33, further comprising subjecting the fitting in combination with the insert part to a painting operation before the transmission rod is inserted into the insert part.
